(19) United States
(12) Patent Application Publication
(10) Pub. No.: US 2003/0024234 A1
(43) Pub. Date: Feb. 6, 2003

(54) Secondary combustor for low NOx gas combustion turbine

(75) Inventors: Richard D. Holm, Pittsburgh, PA (US); Thomas E. Lippert, Murraysville, PA (US); Dennis M. Bachovchin, Delmont, PA (US); Donald M. Newburry, Orlando, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 09/921,108

(22) Filed: Aug. 2, 2001

(51) Int. Cl. F02C 3/16

(52) U.S. Cl. 60/39.463; 60/746

(57) ABSTRACT

A combustion turbine which produces a reduced amount of NOₓ is provided. The combustion turbine reduces the amount of NOₓ produced by utilizing a secondary combustor. By using a secondary combustor the working gas of the combustion turbine does not need to be heated above 2500° F., the temperature at which a substantial amount of NOₓ begins to form, until the working gas is entering the turbine assembly. The secondary combustor assembly heats the working gas by injecting a combustible gas, or compressed air if the primary combustor produces a fuel rich working gas, into the elevated temperature working gas. This gas combusts and heats the working gas adjacent to the beginning of the turbine assembly. Because the working gas is not raised above 2500° F. until it is about to enter the turbine assembly, the time during which NOₓ is formed is reduced.

### BACKGROUND OF THE INVENTION

1. Field of the Invention

This invention relates to combustion turbine power plants and, more specifically, to a secondary combustor which reduces the amount of NOₓ produced by the combustion turbine power plant by heating the working gas to its highest temperature adjacent to the turbine assembly.

2. Background Information

A conventional combustible gas turbine includes a compressor assembly, a combustor assembly, a transition section, and a turbine assembly. The compressor assembly compresses the ambient air. The combustor assembly combines the compressed air with a fuel and ignites the mixture creating a working gas. The working gas travels through the transition section to the turbine assembly. Within the turbine assembly are a series of rows of stationary vanes and rotating blades. Each pair of rows of vanes and blades is called a stage. The rotating blades are coupled to a shaft. As the working gas expands through the turbine assembly, the working gas causes the blades, and therefore the shaft, to rotate.

Conventional cycle combustible gas turbines produce an undesirable amount of Nitrogen Oxide, NOₓ. As described above, combustion turbines operate by passing a heated working gas through a turbine assembly having rows of rotating blades and stationary vanes. The temperature of the working gas may be 2800° F. (1537° C.) or more. Thus, in prior art combustion turbines having a single combustor assembly, the temperature of the working gas must be greater than or about 2800° F. (1537° C.) in the combustor assembly. NOₓ is generally produced in high temperature (2650° F./1455° C. or greater) flame regions of the combustor assembly and the transition to the turbine assembly.

The quantity of NOₓ produced is a function of flame residence time and the time the working gas is at a high temperature, and the value of that temperature. Flame residence time is defined as the time that it takes the working gas to pass through the flame and so is a function of the size of the flame. The flame residence time for prior art combustors is approximately fifteen msec.

In view of air quality emission limitations, it is desirable to reduce the amount of NOₓ produced by a combustion turbine. Reduction in the amount of NOₓ could be accomplished if the temperature in the combustor assembly could be reduced, while maintaining a sufficient temperature for the working gas as it enters the turbine assembly.

Prior-art combustors reduce the amount of NOₓ created by pre-mixing the fuel and air. This method is less than satisfactory as pre-mixing is not completely efficient, resulting a local high fuel/air ratio pockets burning at high temperatures and, because a diffusion pilot flame is often needed to stabilize the combustor flame. The pilot flame, while small, is a high temperature diffusion flame which produces NOₓ. Additionally, the working gas in the transition between the combustor and the turbine may exceed a temperature of about 2800° F. (1538° C.). When the working gas is at this temperature, NOₓ also forms in the transition section.

There is, therefore, a need for a device to heat the temperature of the working gas in the turbine assembly of a combustion turbine power plant so that the working gas may be at a lower temperature within the combustor assembly and the transition section.

There is a further need for a working gas heating device having a low residence time flame.

There is a further need for a working gas heating device which is compatible with existing combustion turbines.

There is a further need for a working gas heating device which incorporates present technology used on combustion turbines.

### SUMMARY OF THE INVENTION

These needs and others are satisfied by the present invention which provides a secondary combustor assembly adjacent to or within the first row of stationary vanes within the turbine assembly, which heats the working gas to a final working temperature just before the working gas passes through the turbine assembly. The primary combustor, which is similar to prior art combustors but operating at a lower temperature, provides a working gas at <2650° F. (1455° C.). Thus, the amount of NOₓ produced in the combustor, as well as in the transition section, is reduced. The working gas at <2650° F. (1455° C.) is delivered to the secondary combustor.

Where the working gas is at <2650° F. (1455° C.), and preferably <2500° F. (1371° C.), the secondary combustor may be in one of three embodiments, or a combination thereof. First, the secondary combustor may be structured to inject fuel in first row of vanes or blades. Second, the secondary combustor may be structured as a fuel injection manifold just ahead of first vane. Third, using a rich primary combustor, the secondary combustor may be structured as an air injection manifold just ahead of first vane.

The secondary combustor of the first embodiment supplies combustible gas through the stationary vanes and/or the rotating blades in a turbine assembly. Many turbine assemblies presently include internal cooling channels within the turbine assembly. Using these channels, the rotating blades and/or stationary vanes to allow a cooling gas or a steam to pass therethrough. The channels may have openings to allow the cooling gas or a cooling steam to join the working gas. The present invention provides a combustible gas, such as, but not limited to, natural gas, through the internal channels of the stationary vanes and/or rotating blades. As the combustible gas exits openings along the trailing edges of the stationary vanes and/or rotating blades, the combustible gas will spontaneously combust, or “auto-ignite,” upon being exposed to the heated working gas. The flame produced in the rotating blade and/or stationary vane portion of a turbine has a low residence time (typically 5 msec. or less), yet still provides enough energy to heat the working gas to a working temperature as the working gas enters the turbine assembly. Additionally, the openings along the trailing edge have a diameter of about 0.125 inch or less. The flames extending from these openings are micro-diffusion flames. That is, the flames do not have a surface area much greater than the surface area of the openings (0.012 in.²).

Alternatively, a manifold with small fuel injection holes may be installed just before the first turbine vane to add fuel to raise the working gas temperature to its final value. Again, a fuel is introduced into the working gas stream and will auto-ignite.

With the working gas being heated in the rotating blade and/or stationary vane portion of the turbine assembly, the working gas may leave the combustor assembly at a much lower temperature, typically less than 2500° F. (1371° C.). Because substantial amounts of NOₓ are created at a temperatures greater than about 2650° F. (1455° C.), the reduction in temperature greatly reduces the amount of NOₓ produced by the combustion turbine power plant. No significant amount of NOₓ is created in the rotating blade and/or stationary vane portion of the turbine due to the low residence time of the flame and the minimal amount of time the working gas is >2650° F. (1538° C.).

Another alternative embodiment uses a rich primary combustor to heat the working gas initially. The rich primary combustor limits the amount of air, and therefore oxygen, in the combustor. Thus, only a portion of the fuel combusts, raising the temperature of the working gas and unburned fuel to about 1600° F. (871° C.). To allow the unburned fuel to combust, compressed air is passed through channels and effusion openings at the downstream end of the transition section. When the compressed air mixes with the combustible gas, the unburned fuel will auto-ignite, raising the temperature of the working gas to a working temperature just as the working gas enters the turbine assembly. The primary rich combustor may be catalytic.

The secondary combustor further provides advantage of having a primary combustion assembly which operates at a temperature approximately 800° F. (426° C.) lower than prior combustion turbines. A cost-savings can be realized by designing the combustor assembly and transition section to operate at the lower temperature. However, this device may also be used with current combustion turbine power plants which incorporate cooling passageways in the rotating blades and/or stationary vanes that are open to the working gas flow path.

### BRIEF DESCRIPTION OF THE DRAWINGS

FIG. 1 is a partial cross section of a combustion turbine showing the combustor assembly, the transition section, and the turbine assembly having a secondary combustor assembly among the turbine vanes.

FIG. 2 is a cross sectional view of a vane incorporating fuel injection openings.

FIG. 3 is a cross section of a combustion turbine showing the combustor assembly, the transition section, and the turbine assembly having a secondary combustor as a fuel manifold.

FIG. 4 is a cross section of a combustion turbine showing the combustor assembly, the transition section, and the turbine assembly having a secondary combustor in the transition section.

### DESCRIPTION OF THE PREFERRED EMBODIMENT

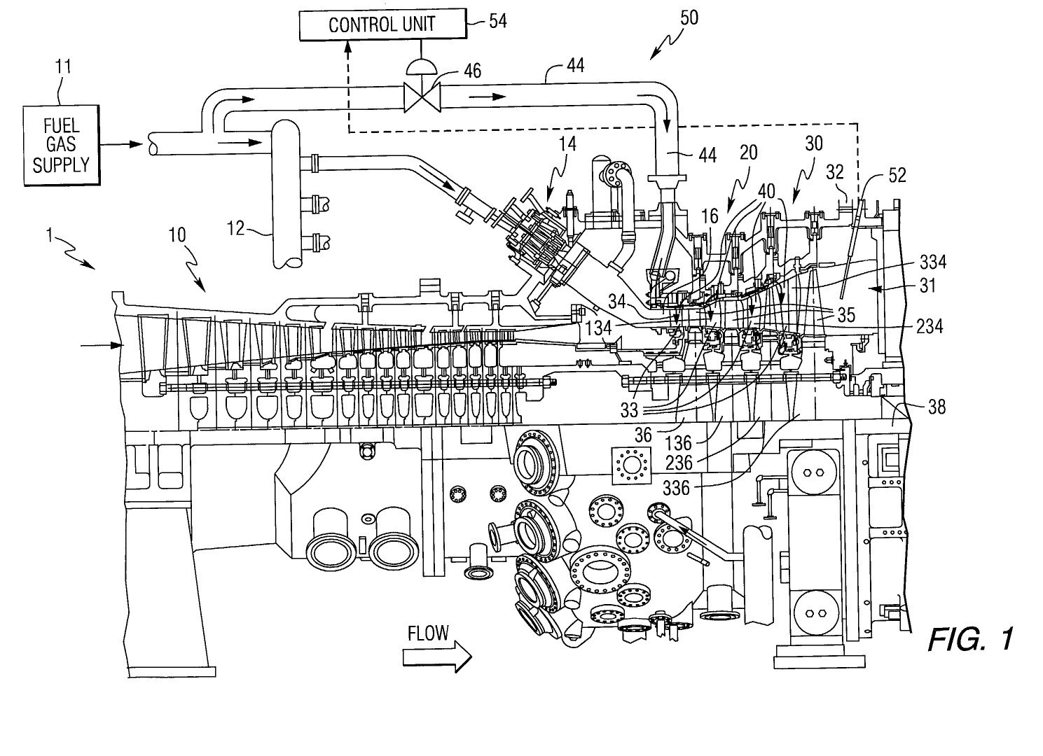

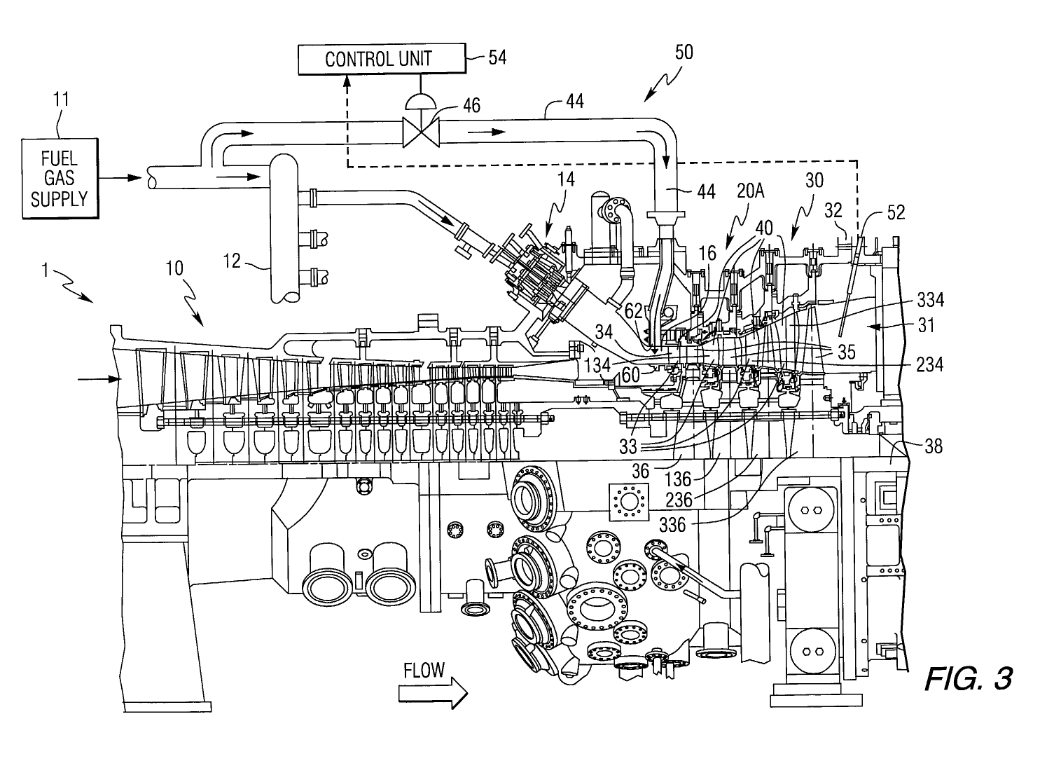

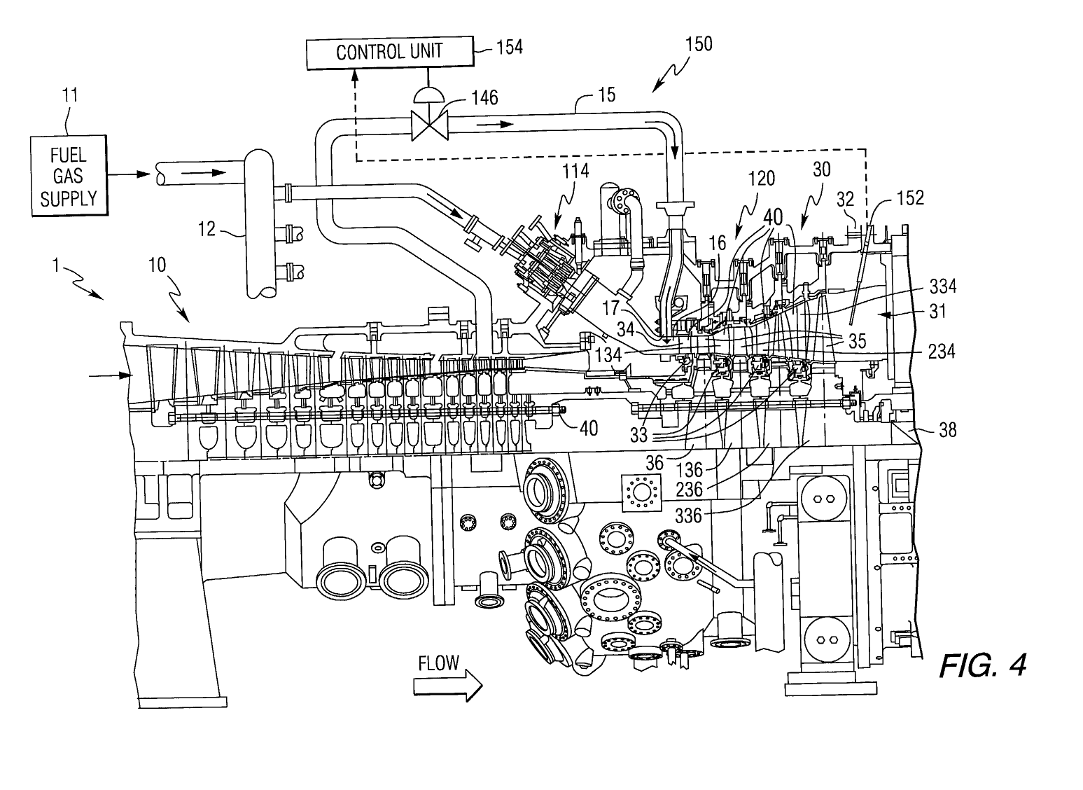

As shown in FIG. 1, a combustion turbine power plant 1 includes a compressor assembly 10, a combustible gas source 11, a fuel delivery system 12, a primary combustor assembly 14, a transition section 16, a secondary combustor assembly 20, 20A (as shown in FIG. 3), 120 (as shown in FIG. 4) and a turbine assembly 30. The secondary combustor assembly 20, 20A, or 120 is located adjacent to the first row of vanes 34 (described below) in the turbine assembly 30. The transition section 16 may have a plurality of effusion openings 17 (FIG. 4) located at its down stream end. Each opening is about 0.125 inches or less in diameter.

In operation, the compressor assembly 10 inducts ambient air and compresses the air. The compressed air is channeled into the primary combustor assembly 14. The primary combustor assembly 14 is coupled to the combustible gas source 11 through the fuel delivery system 12. In the primary combustor assembly 14, a combustible gas and the compressed air are mixed and ignited, thereby forming a working gas. The working gas in the primary combustor assembly 14 is at a temperature of less than about 2500° F. (1371° C.). The working gas is channeled from the primary combustor assembly 14 into the transition section 16. The transition section 16 is coupled to both the primary combustor assembly 14 and the turbine assembly 30.

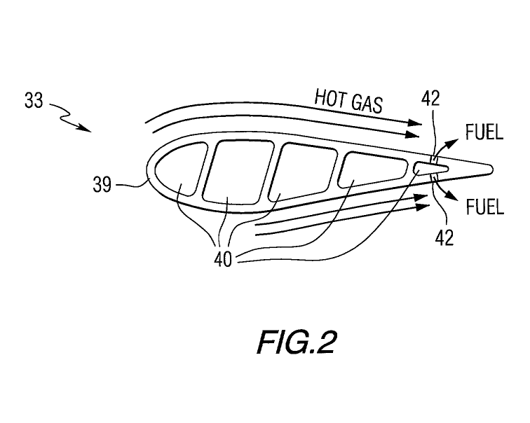

A turbine assembly 30 includes an elongated outer casing 32 defining a channel 31 which is the flow path for the working gas. A plurality of stationary vanes 33 are disposed in a first row 34 within the casing 32. There may be additional rows 134, 234, 334 of stationary vanes 33. A plurality of rotating blades 35 are disposed in at least one row 36, extending circumferentially from a central shaft 38. There may be additional rows 136, 236, 336 of rotating blades 35. Shaft 38 extends axially within casing 32. The rows of rotating blades 36, 136, 236, 336 are spaced to fit within the interstices between the rows of stationary vanes 34, 134, 234, 334. As shown in FIG. 2, each of the vanes 33 or blades 35 have airfoil shaped bodies 39.

The secondary combustor assembly 20, 20A, (FIG. 3), 120 (FIG. 4) is structured to heat the working gas to a temperature of about 2800° F. (1538° C.) at a location proximal to the down stream end of the transition section 16 and the first row of vanes 34 in the turbine assembly 30. The secondary combustor 20, 20A, 120 assembly heats the working gas by injecting a gas into the elevated temperature working gas. The gas injected by the secondary combustor 20, 20A, 120 may be either a combustible gas or, if the primary combustor is fuel-rich, compressed air or oxygen.

In one embodiment, shown in FIG. 1, the secondary combustor assembly 20 is a plurality of openings disposed among the vanes 33 and/or blades 35 which are coupled to the combustible gas source 11. The combustible gas is injected into the flow stream. As the combustible gas is injected into the elevated temperature working gas, the combustible gas will auto-ignite. That is, the combustible gas will combust without the need for an igniter or pre-existing flame.

In another embodiment, shown in FIG. 3, the secondary combustor assembly 20A is a fuel manifold 60 with fuel injection openings 62 disposed just before the first turbine vane 34. The fuel manifold 60 is coupled to the combustible gas source 11. The combustible gas is injected through the fuel manifold 60 into the flow stream. As the combustible gas is injected into the elevated temperature working gas, the combustible gas will auto-ignite.

In another embodiment, shown in FIG. 4, the secondary combustor assembly 120 cooperates with a fuel rich primary combustor assembly 114 (described below with respect to FIG. 4) which produces a fuel rich working gas. The fuel-rich primary combustor assembly 114 may be a catalytic combustor. In this embodiment, compressed air or oxygen is injected into the transition section 16, via effusion openings 17, adjacent to the turbine assembly 30. As the compressed air/oxygen mixes with the fuel rich working gas, the mixture auto-ignites. The flame caused by auto-ignition has a low residence time.

In one embodiment, shown in FIG. 1, the secondary combustor assembly 20 includes a secondary combustible gas pipe assembly 44 and internal channels 40 (FIG. 2) within the airfoil bodies 39 of the vanes 33 and/or blades 35. The internal channels 40 are coupled to openings 42 (FIG. 2) along the trailing edge of the airfoil bodies 39. The openings 42 are sized to create micro-diffusion flames and are about 0.125 inches or less in diameter. There are about twenty openings 42 spaced along the trailing edge of each body 39. The internal channels 40 of the stationary vanes 33 and/or rotating blades 35 are coupled to the fuel delivery system 12 by pipe 44 or other such passageway. Combustible gas may pass through the secondary combustible gas pipe assembly 44 and into the internal channels 40. By coupling the fuel delivery system 12 to the internal channels 40, there is a continuous path between the combustible gas source 11 and the openings 42 in the vanes 33 and/or blades 35. Thus, the combustible gas is provided to the first row of vanes 34 and/or blades 36 in the turbine assembly 30. The first row of vanes 34 is adjacent to transition section 16 and is, effectively, the beginning of the turbine assembly 30.

The secondary combustible gas pipe assembly 44 may include at least one valve 46 for controlling the amount of combustible gas passing therethrough and a control system 50. The control system 50 includes at least one sensor 52, such as a temperature sensor, pressure sensor, or mass flow sensor, which gathers data relating to the condition of the working gas. The sensor 52 converts the data into an electrical output signal which is provided to a control unit 54. The control unit 54 receives the output signal from said sensor and determines a parameter indicative of a characteristic, e.g. the temperature, of the working gas compared to a selected standard. The control unit 54 is also coupled to the valve 46 and will increase or decrease the flow of combustible gas through the valve 46 relative to the results of the comparison, to achieve a working gas temperature approximately equal to the selected standard.

In operation, a portion of the combustible gas travels from the fuel delivery system 12 through the pipe 44 to the internal channels 40 of the stationary vanes 33 and/or rotating blades 35. As the combustible gas travels through the internal channels 40 of the stationary vanes 33 and/or rotating blades 35, the combustible gas absorbs heat thereby cooling the stationary vanes 33 and/or rotating blades 35. When the combustible gas reaches one of the openings 42, it passes into the working gas stream. When the combustible gas enters the working gas stream it will auto-ignite thereby heating the working gas. Preferably, the openings 42 are sized to create micro-diffusion flames having a low residence time, preferably less than 0.5 msec.

In the primary combustor assembly 14, the working gas is heated to about 2000° F. (1093° C.). The working gas maintains this temperature through transition section 16. In the secondary combustor assembly 20, combustible gas is injected into the working gas, preferably from the first row of vanes 34. At a temperature at or about 2000° F. (1093° C.), the combustible gas will auto-ignite, producing a micro-diffusion flame. The micro-diffusion flame heats the working gas to a temperature of about 2800° F. (1538° C.) just as the working gas enters the majority of the turbine assembly 30. The heating of the working gas by the secondary combustor assembly 20 may be controlled by the valve 46 working in conjunction with the control system 50.

An existing combustion turbine power plant can be adapted to have a secondary combustor assembly 20 by isolating the internal channels 40 in the first row of vanes 34 from the internal channels 40 within the other rows of vanes 134, 234, 334. This may require replacing the first row of vanes 34 with new vanes 34 which have channels 40 which do not communicate with the channels 40 in other rows of vanes 134, 234, 334. Thus, only the channels 40 in the first row of vanes 34 are coupled to the combustible gas pipe assembly 44. The channels 40 in the subsequent rows of vanes 134, 234, 334 may still be coupled to a cooling gas or steam source (not shown) if desired.

In an another embodiment, shown in FIG. 3, the components of the combustion turbine power plant 1 are substantially the same as described above, however, the secondary combustor 20A injects the fuel through a fuel manifold 60 disposed just before the first turbine vane 34. In this embodiment, the fuel delivery system 12 and pipe 44 are connected to the fuel manifold 60. The fuel manifold 60 has a plurality of openings 62 in fluid communication with the transition section 16. Again, the fuel is injected into the heated working gas just before the turbine assembly 30. When the fuel auto-ignites, the working gas is heated to a working temperature of about 2800° F. (1538° C.) just as the working gas enters the majority of the turbine assembly 30. In this embodiment, the channels 40 within the vanes 33 and blades 35 may be used to cool the turbine assembly 30 components. Alternatively, the first and second embodiments may be combined so that fuel is injected through both the vanes and blades 33, 35 and a fuel manifold 60.

In an another embodiment, shown in FIG. 4, the working gas is heated in a secondary combustor assembly 120 located in the transition section 16. In this embodiment, the compressor assembly 10 includes a compressed air pipe assembly 15. A portion of the compressed air from the compressor assembly 10 is passed through the compressed air pipe assembly 15 to effusion openings 17 at the downstream end of the transition section 16 adjacent to the turbine assembly 30. By using a fuel rich primary combustor assembly 114, which limits the amount of combustible gas burned by limiting the amount of compressed air, and therefore oxygen, available to combust the fuel, combustible gas is provided in the working gas. The working gas and the portion of unburned combustible gas are heated to a temperature of about 1600° F. When the unburned combustible gas combines with the compressed air, and oxygen, in the transition section 16, the combustible gas will auto-ignite, heating the working gas to about 2800° F. just as it enters the turbine assembly 30. The secondary combustor assembly 120 creates micro-diffusion flames having a low residence time, preferably less than 5 msec. The compressed air pipe assembly 15 includes a valve 146 and control system 150, having a sensor 152 and control unit 154, similar to the control system 50 described above.

While specific embodiments of the invention have been described in detail, it will be appreciated by those skilled in the art that various modifications and alternatives to those details could be developed in light of the overall teachings of the disclosure. For example, the both fuel rich primary combustor assembly 114 and transition section secondary combustor assembly 120 as well as a vane and/or blade secondary combustor assembly 20 may be incorporated into a single system. In such a system, the working gas is heated three times; first by the fuel rich combustor assembly 114, then by the transition section secondary combustor assembly 120, then by the vane and/or blade secondary combustor assembly 20. Only the vane and/or blade secondary combustor assembly 20 raises the working gas temperature to about 2800° F. Accordingly, the particular arrangements disclosed are meant to be illustrative only and not limiting as to the scope of invention which is to be given the full breadth of the claims appended and any and all equivalents thereof.

What is claimed is:

1. A combustion turbine comprising:
a combustible gas source;
a compressor assembly which compresses ambient air;
a primary combustor assembly coupled to said compressor assembly and to said combustible gas source which mixes said compressed air and combustible gas and ignites the mixed gasses thereby creating a working gas with an elevated temperature;
a transition section coupled to said primary combustor assembly;
a turbine assembly coupled to said transition section;
said compressor assembly, primary combustor assembly, transition section and turbine assembly defining a flow path; and
a secondary combustor assembly structured to heat the working gas proximate to the downstream end of the transition section.

2. The combustion turbine of claim 1 wherein the secondary combustion assembly is structured to create a flame having a flame residence time of less than 5 msec. by injecting a gas into the working gas.

3. The combustion turbine of claim 1 wherein the secondary combustor assembly is structured to raise the temperature of the working gas to about 2800° F. (1537° C.) as it enters the turbine assembly.

4. The combustion turbine of claim 1 wherein the secondary combustor assembly comprises:
said turbine assembly having a plurality of rotating blades and stationary vanes disposed in said flow path;
said plurality of vanes and blades disposed in rows within said turbine assembly;
said blades and vanes having bodies with internal channels;
a secondary combustible gas pipe assembly coupled to said combustible gas source and said internal channels; and
a plurality of openings on said bodies allowing fluid communication between said internal channels and said flow path;
whereby said combustible gas may enter said flow path through the plurality of openings in the bodies and auto-ignite upon contact with the elevated temperature working gas.

5. The combustion turbine of claim 4, wherein said openings are sized to create micro-diffusion flames.

6. The combustion turbine of claim 5, wherein said plurality of openings consist of about 20 openings.

7. The combustion turbine of claim 6 wherein each opening has a diameter of about 0.125 inch or less.

8. The combustion turbine of claim 7, wherein said bodies are airfoils and said openings are located on the trailing edge of said bodies.

9. The combustion turbine of claim 8, wherein said secondary combustible gas pipe assembly includes a means to control the flow of combustible gas.

10. The combustion turbine of claim 9, wherein said means to control the flow of combustible gas is a valve.

11. The combustion turbine of claim 10, wherein:
said secondary combustible gas pipe assembly includes a control system which opens or closes said valve;
said control system includes:
a sensor disposed within said turbine assembly which provides an electric output; and
a control unit coupled to said valve and coupled to said sensor;
said control unit receiving said electric output from said sensor and determining a parameter indicative of a characteristic of the working gas compared to a selected standard and increases or decreases the flow of combustible gas through said valve relative to the results of the comparison, to achieve a working gas temperature approximately equal to the selected standard.

12. The combustion turbine of claim 11 wherein the parameter detected is the temperature of the working gas.

13. The combustion turbine of claim 1, wherein:
said combustor assembly is a fuel rich primary combustor coupled to said compressor and to said combustible gas source which mixes said compressed air and combustible gas and ignites the mixed gasses thereby creating a fuel rich working gas having an elevated temperature;
said transition section has a plurality of effusion openings;
a turbine assembly coupled to said transition section;
a secondary combustor comprising:
a compressed air pipe assembly;
said air pipe assembly coupled to said compressor and said transition section plurality of openings; and
whereby compressed air passes through the compressed air pipe assembly and mixes with the fuel rich working gas and said fuel rich working gas auto-ignites upon contact with said compressed air.

14. The combustion turbine of claim 13, wherein said effusion openings are sized to create micro-diffusion flames.

15. The combustion turbine of claim 14, wherein each said effusion opening has a diameter of about 0.125 inch.

16. The combustion turbine of claim 15, wherein said compressed air pipe assembly includes a means to control the flow of compressed air.

17. The combustion turbine of claim 16, wherein said means to control the flow of compressed air is a valve.

18. The combustion turbine of claim 17, wherein:
said secondary combustible gas pipe assembly includes a control system which opens or closes said valve;
said control system includes:
a sensor disposed within said turbine assembly which provides an electric output; and
a control unit coupled to said valve and coupled to said sensor;
said control unit receiving said electric output from said sensor and determining a parameter indicative of a characteristic of the working gas compared to a selected standard and increases or decreases the flow of combustible gas through said valve relative to the results of the comparison, to achieve a working gas temperature approximately equal to the selected standard.

19. The combustion turbine of claim 18 wherein the parameter detected is the temperature of the working gas.

20. The combustion turbine of claim 1 wherein:
said secondary combustor assembly includes a fuel manifold disposed adjacent to said turbine assembly;
said fuel manifold having a plurality of openings in fluid communication with said transition section;
a secondary combustible gas pipe assembly coupled to said combustible gas source and said fuel manifold; and
whereby said combustible gas may enter said flow path through the plurality of openings in said fuel manifold and auto-ignite upon contact with the elevated temperature working gas.
